(19) United States
(12) Patent Application Publication
(10) Pub. No.: US 2012/0093460 A1
(43) Pub. Date: Apr. 19, 2012

(54) LIGHT GUIDE FOR ILLUMINATION

(75) Inventors: Gabriel-Eugen Onac, Veldhoven (NL); Michel Cornelis Josephus Marie Vissenberg, Roermond (NL)

(73) Assignee: Koninklijke Philips Electronics N.V., Eindhoven (NL)

(21) Appl. No.: 13/380,542

(22) PCT Filed: Jun. 14, 2010
(86) PCT No.: PCT/IB2010/052636

§ 371 Date: Dec. 23, 2011

(30) Foreign Application Priority Data
Jun. 23, 2009 (EP) 09163433.7

(51) Int. Cl. G02B 6/26

(52) U.S. Cl. 385/27

(57) ABSTRACT

It is presented a light guide (1) having a polygonal shape with a plurality of sides (5), each side (5) connected by two corners (5). At least one of the corners is an in-coupling corner (4) for in-coupling of light into the light guide (1). At least one of the sides (5) has is slanting and collimates light in-coupled from an adjacent light in-coupling corner (4). The slanting side (5) can also reflect light towards a planar light emitting surface (3) for out-coupling of light therethrough. The light in-coupled in a light in-coupling corner (4) is collimated as if the light guide (1) is an equilateral triangle (2) having three slanting sides.

### FIELD OF THE INVENTION

The technical field of the invention is lighting. In particular, the present invention relates to a light guide and a luminaire comprising such a light guide.

### BACKGROUND OF THE INVENTION

The rapid development of solid state light sources over the last decade anticipates a large-scale use of Light Emitting Diodes (abbreviated LED) for general illumination. In particular, the increase in the amount of light (lumens—abbreviated lm) per package, the higher efficiency (lm/W), as well as the continuous decrease of the cost (lm/dollar) for LED sources, lead to the prediction that over the next several years LED lighting will be introduced on a large scale in the general illumination market.

Light systems using LED's can benefit from several advantages over conventional fluorescent luminaries, while having similar or better efficiencies. These include fundamental properties like lifetime, but also a better flexibility in terms of sizes and shapes for the light emitting area conferred by the use of multiple small light sources.

At the same time general illumination systems based on LEDs need to fulfill several requirements. Because LEDs are very bright sources light needs to be spread and out-coupled over a larger area (compared to the light emitting area of the LED). Furthermore, anti-glare regulations require the intensity at large angles (from the vertical direction) is below certain thresholds (e.g. less than 1000 cd/m² for angles larger than 65°).

US patent application 2009/0046468 discloses a light guide block into which light from a point source such as an LED is in-coupled via a receiving hole therein. Light is directed via a prism array to a light exit surface for out-coupling of light. However, this solution does not suit particularly well for general illumination purposes, because it has a complicated design, it's bulky and lacks an appealing presentation to a user.

### SUMMARY OF THE INVENTION

It is with respect to the above considerations and others that the present invention has been made.

In view of the above, it would therefore be desirable to achieve an improved light guide. In particular, it would be advantageous to achieve a simple light guide that out-couples light in a collimated way and which can be used to create luminaries of different shapes and sizes.

To better address one or more of these concerns it is provided a light guide having a polygonal shape with a plurality of corners and a plurality of sides, each side connecting two corners, the light guide having a planar light emitting surface, wherein at least one of said corners is a light in-coupling corner adapted to allow in-coupling of light into the light guide, wherein at least one side adjacent to the in-coupling corner is a slanting side forming an acute angle with respect to the light emitting surface, the slanting side being adapted to collimate light in-coupled by the light in-coupling corner and to redirect light towards the planar light emitting surface, and wherein remaining sides are formed such that light in-coupled in the in-coupling corner is collimated as if the light guide is an equilateral triangle having three slanting sides.

The light guide is thus designed such that collimation of the in-coupled light is effected as if the light guide was an equilateral triangle with slanting sides, even if the light guide has a different shape. For example, and as will be further elaborated below, a geometrical shape with only one or two slanting sides may be perceived as an equilateral triangle with three slanting sides by providing one or several reflective walls. Note that, although the collimating function of the light guide will be that of an equilateral triangle with slanting sides, the out-coupling will typically depend on the number of slanting sides.

The light guide according to the invention may be used as a simple one-component light guide providing collimation of in-coupled light. In particular, by providing a light guide in which at least one side is slanting with an acute angle α in relation to the planar light emitting surface, and in which light perceives the light guide as an equilateral triangle, several optical functions may be achieved in a unibody optical component. More specifically, the slanting side adjacent an in-coupling corner may collimate incident light from an adjacent in-coupling corner in two directions.

By the property of a being a side of a real or imaginary triangle, the slanting side can collimate incident light in a plane parallel to the planar light emitting surface by redirecting light by e.g. total internal reflection. The same light beam may typically also have a component in a plane perpendicular to the light emitting surface. Reflection in the slanting side will then also rotate the beam in a plane perpendicular to the planar light emitting surface. This rotation will have the effect of a second collimation, in a plane perpendicular to the light emitting surface, without disturbing the collimation in the plane parallel to the planar light emitting surface.

In-coupled light will eventually be incident on a slanting side in a direction substantially normal to this side of the real or imaginary triangle. The light will then be redirected steeply against the planar light emitting surface, and be out-coupled from the light guide.

According to one embodiment, the light guide has three slanting sides forming an equilateral triangle. Light in-coupled at a corner will then be collimated twice by the adjacent slanting sides and redirected towards a slanting side opposite to that in-coupling corner. When impacting with the opposite slanting side, light will be redirected towards the planar light emitting surface for out-coupling therethrough.

In one embodiment, all corners may be light in-coupling corners. Thereby, a more efficient light guide may be provided utilizing all three sides of the equilateral triangle for light collimation and redirection for out-coupling.

The slanting sides may converge to a common point thereby forming a three-sided pyramid. The light guide will be provided with larger surfaces for redirection/collimation of light towards the planar light emitting surface. An effect which may be achievable thereby is that the light may be spread over a larger area when out-coupled, which may provide a locally less bright light guide. Moreover, the beam cut-off may be better defined.

As an alternative to each pair of adjacent side having 60° between them, at least one the remaining sides may be defined by a line of a symmetry axis of the equilateral triangle. By e.g. cutting along symmetry axis/axes of the equilateral triangle, a light guide having a different shape may be achieved.

At least one side may be a reflecting wall normal to the planar light emitting surface and extend along a symmetry axis of the equilateral triangle. The light guide may then still enjoy the advantages of the equilaterally triangular shaped light guide in addition to providing more freedom for selecting a shape of the light guide.

The light in-coupling corner may be defined by an in-coupling surface formed between adjacent slanting sides. Thereby, efficient in-coupling of light into the light guide may be achieved. By placing e.g. an LED adjacent the in-coupling surface, more light may be in-coupled into the light guide.

The light guide may have a planar top surface, wherein the planar top surface and the planar light emitting surface converge towards each other in at least one corner, wherein the surfaces converge until intersecting the in-coupling surface. Beneficially, more collimated in-coupling into the light guide may thereby be achievable. In particular, the four slanting surfaces converging towards the in-coupling surface at the corner each provide collimation parallel with the planar light emitting surface. By providing such collimation, fulfillment of present anti-glare norms for e.g. downlight applications may be achieved.

The at least one light in-coupling corner may have a rectangular shaped in-coupling surface. Thereby a light source such as an LED may more efficiently interface with the in-coupling surface providing less light leakage between the light guide and the light source.

A plurality of light guides may be used to construct a luminaire. The luminaire may comprise at least one Light Emitting Diode located at a light in-coupling corner of at least one light guide. Thereby, a wide range of shapes for the design of a luminaire may be provided.

The at least one LED may be in-coupled in at least one light-in coupling corner of each of at least two light guides of the plurality of light guide. A more flexible design of the luminaire may thereby be provided.

The above aspect and others of the invention will be apparent from and elucidated with reference to the embodiments described hereinafter.

### BRIEF DESCRIPTION OF THE DRAWINGS

This and other aspects of the present invention will now be described in more detail, with reference to the appended drawings showing embodiment(s) of the invention.

FIG. 1 shows a perspective view of a first embodiment of a light guide according to the invention.

FIG. 2 shows a luminaire according to one embodiment of the invention.

FIGS. 3a-c shows light propagation in the light guide in FIG. 1.

FIG. 4 shows a second embodiment of a light guide according to the invention.

FIG. 5 shows a third embodiment of a light guide according to the invention.

FIG. 6 shows a fourth embodiment of a light guide according to the invention.

FIG. 7 shows a schematic view of an equilateral triangle where each of its symmetry axes are visible.

FIGS. 8a-c show luminaries comprising a plurality of light guides according to embodiments of the invention.

FIG. 9a-c shows luminaries according to one embodiment of the invention.

### DETAILED DESCRIPTION

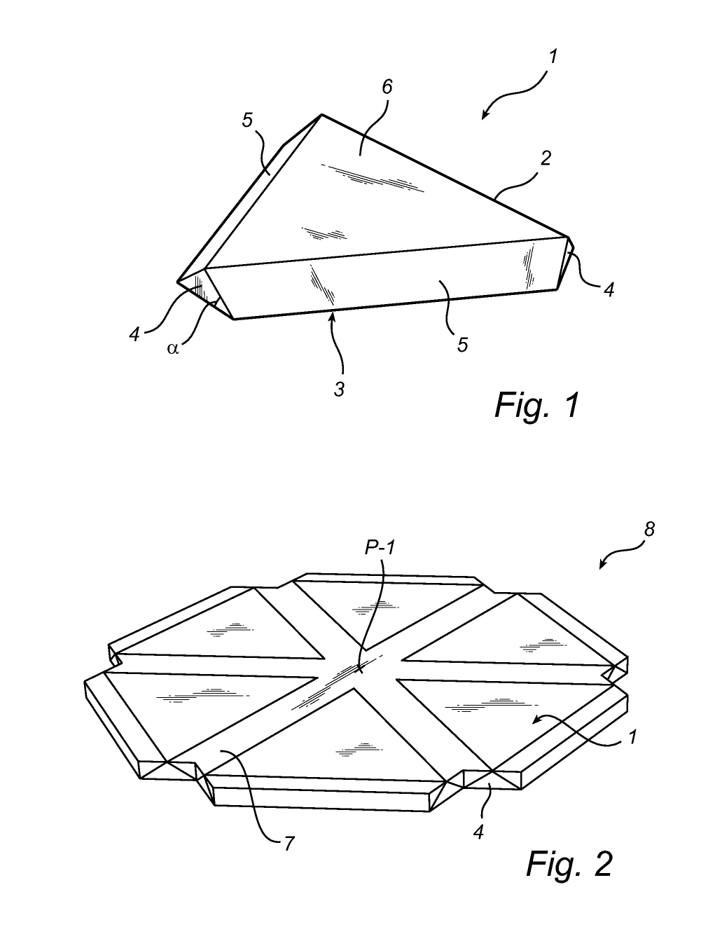

With reference to FIG. 1, a first embodiment of a light guide 1 is shown. The light guide 1 has the shape of an equilateral triangle 2 and has a planar light emitting surface 3, a planar top surface 6, three light in-coupling corners 4 and three slanting sides 5, each defining a redirecting surface. Each slanting side defines an acute angle α with the light emitting surface 3. The acute angle can for instance be between 30° and 65°. The in-coupling corners 4 are arranged to allow in-coupling of light into the light guide, and are here formed as flat surfaces, i.e. as truncated corners.

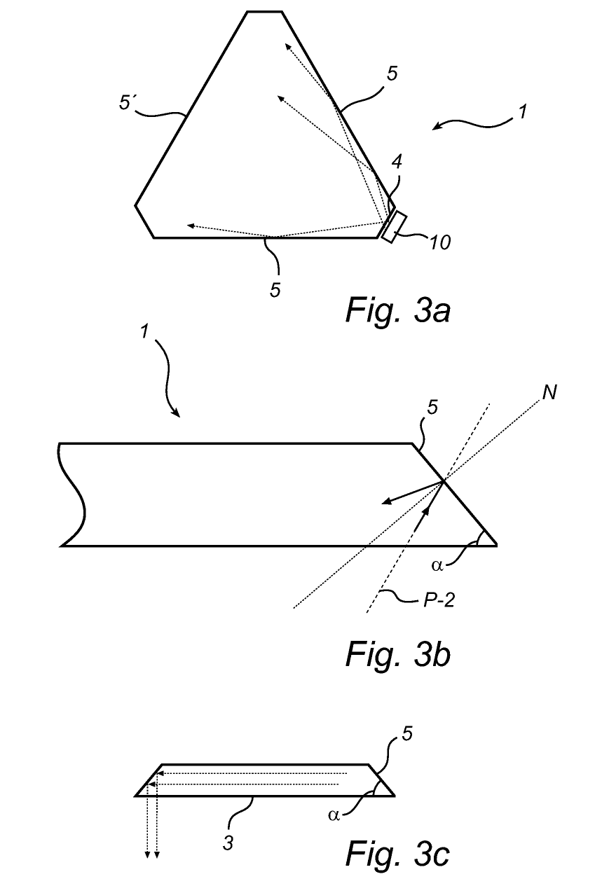

By placing an LED 10 (see FIG. 3a) adjacent a corner 4, light can be in-coupled into the light guide 1. In-coupled light is collimated and redirected in the light guide 1, via the two adjacent slanting sides 5, towards the slanting side 5 opposite the in-coupling corner 4. When the opposite slanting side 5 receives the collimated light it redirects light towards the planar light emitting surface 3. In FIGS. 3a-c, the light collimation/redirection process in the light guide 1 will be described in more detail.

Thus, the slanting side 5 opposite an in-coupling corner 4 is the main out-coupling side for that in-coupling corner 4.

Due to the geometry of the light guide 1, a single component optical element which collimates and out-couples light may be achieved. In particular, each slanting side 5 has several optical functions providing an unexpected significant effect in that each side 5 collimates light in two planes, and also redirects light for out-coupling through the planar light emitting surface 3.

Beneficially, the light guide 1 spreads the light and out-couples the light over a large area compared to the light emitting area of the light source. Thereby anti-glare regulations may be maintained and an efficient luminaire inheriting all the advantageous properties of e.g. an LED light source may be obtained. Further, the light guide 1 provides an efficient, one-component light guide with simple design.

Further applications of the light guide 1 will now be illustrated with reference to FIG. 2. By tiling a plurality of light guides 1, a luminaire 8 may be designed. Hence, light guides 1 can be utilized for constructing luminaries 8 of advanced shapes.

As shown in the example in FIG. 2, six light guides 1 may be tiled together with one corner 4 of each light guide 1 pointing inwardly towards a common central point P-1 of the luminaire 8. By placing the light guides 1 adjacent each other, a hexagonal shaped luminaire 8 can be created. A filling member 7 may be arranged to fill the gap between the light guides, and may have reflecting surfaces adjacent any slanting surface. Such a filling member 7 may achieve more efficient light out-coupling through the planar light emitting surfaces 3 of each light guide 1. Thereby light not fulfilling total internal reflection conditions in the light guides 1 may also be out-coupled through the planar light emitting surface 3.

Moreover, a thin diffuser (not shown) may be placed on the luminaire 8 to smear out the six fold symmetry. This can be a weak, normal or a holographic diffuser. Light from LEDs can be in-coupled at each corner 4 of the light guides 1.

Alternatively, the common central point P-1 of the luminaire 8 can be a common in-coupling point where one or more LEDs can be placed in a “mixing cavity” in the middle of the hexagonal structure.

Further designs may for instance include any type of rotationally symmetric layouts for e.g. down light applications, and rectangular luminaries. Thus each luminaire design can be based on the same optical building block, i.e. light guide 1. Furthermore the luminaire can be made very thin (<5 mm) and can be partially transparent which makes it attractive also from a design point of view. The light guide 1 can for instance be manufactured of partially transparent or transparent plastic material such as PMMA.

With reference to FIGS. 3a-b, the light propagation in the light guide 1 in FIG. 1 will now be described in more detail.

Light is in-coupled into the light guide 1 via an in-coupling corner 4. The light source is preferably a bright light source such as LED 10. As illustrated in FIG. 3a, a top view of the light guide 1 shows examples of direction of propagation of light rays therein. Light emanating from the LED 10 entering the light guide 1 is not collimated and spreads in all directions when propagating in the light guide 1 before impacting with anyone of the adjacent slanting sides 5. The adjacent slanting sides 5 normally collimate light in two directions. The first type of collimation will be described with reference to FIG. 3a.

Upon impact with the adjacent slanting sides 5, the light is redirected towards the slanting side 5′ opposite the in-coupling corner 4. Light impeding on the adjacent slanting sides 5 can be directed towards the opposite slanting side 5′ via e.g. total internal reflection. However, upon impact, light is also collimated in another direction, as will be described below.

As shown in FIG. 3b, a second type of collimation by rotation may also be achieved by the adjacent slanting sides 5 of the light guide 1. Since light propagates in three dimensions, light may also travel in a plane P-2 intersecting the planar light emitting surface 3. The slanting property of the slanting sides 5 then provides for the rotation of the light beam when colliding with the slanting side 5. The rotation occurs in a plane transverse to the planar light emitting surface 3, which plane also intersects the slanting side 5 which the light has just impacted.

Thereby light will not only be collimated in one plane (parallel with the planar light emitting surface 3) but in two planes (in a plane transverse to the planar light emitting surface 3).

When the collimated light reaching the slanting side 5′ opposite the in-coupling corner 4, it will be reflected towards the planar light emitting surface 3 for out-coupling there through.

Thus, each slanting side 5 adjacent an in-coupling corner 4 has the functions of: lateral (first) collimation in a plane parallel to the planar light emitting surface 3, and rotating the incoming light beam for a (second) collimation of light in a plane substantially normal to the planar light emitting surface 3. The first collimation is unaffected by the second collimation. Further, each slanting side 5′ opposite an in-coupling corner redirects collimated light provided by the adjacent slanting sides 5, for out-coupling through the planar light emitting surface 3.

To this end, light propagating towards a slanting side 5 will always meet an inclined redirecting surface 5′. The inclination is provided by the equilateral triangular shape 2 of the light guide 1, or the inclination due to slanting of the slanting sides 5. Reflection in both cases redirects the light, providing collimated light in the light guide 1 propagating towards the opposite side slanting side 5. Upon impact, which ideally is substantially normal to the extension of the redirecting surface 5′, light once again meets an inclined redirecting surface in the slanting of the opposite slanting side 5 defined by an acute angle α with the planar light emitting surface 3. Thereby, light can be redirected via e.g. total internal reflection towards the planar light emitting surface 3, as shown in FIG. 3c.

Hence, a simple unibody light guide 1 can be provided, which may be used as a building block for the creation of luminaries 8 of advanced, custom-specified shapes.

For an alternative out-coupling effect not being dependent on total internal reflection, the slanting surfaces 5 may be provided with reflecting surfaces.

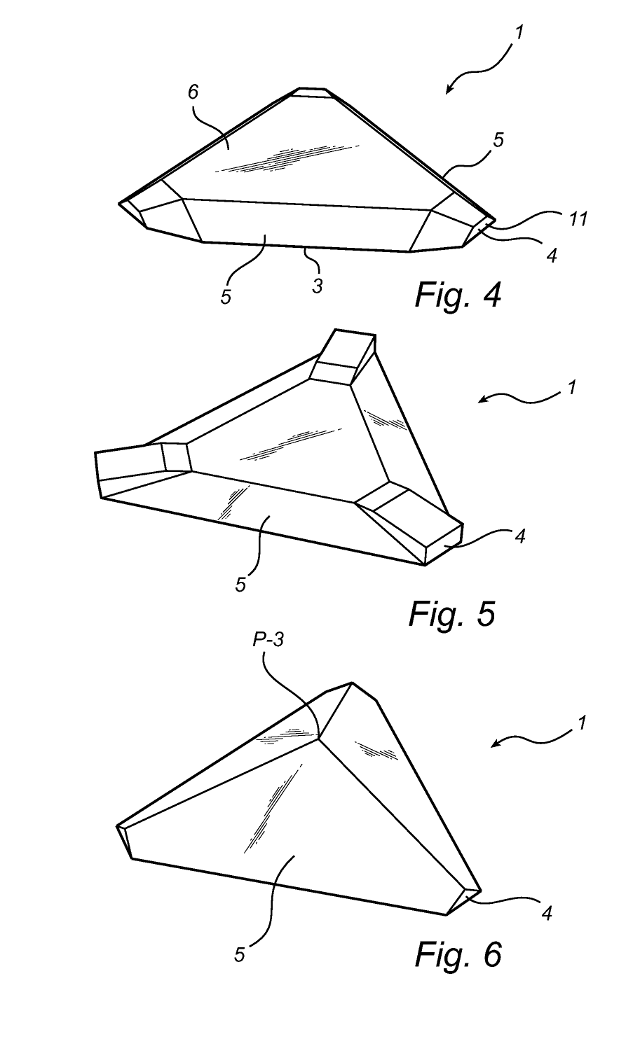

Various embodiments of the invention will now be described with reference to FIGS. 4-9.

FIG. 4 shows a second embodiment of the light guide 1 according to the invention. The functioning of the present embodiment of the light guide 1 is the same as described hereabove. However, the in-coupling corners 4 are tapered to improve collimation in the light guide 1.

As each adjacent slanting side 5 of the equilateral triangle converge to a corner 4, the planar light emitting surface 3 and a planar top surface 6 start to converge towards each other. The top surface 6 and the light emitting surface 3 converge towards each other until intersecting a surface 11 formed between two adjacent slanting sides 5, which surface 11 defines the in-coupling corner 4. A tapered in-coupling corner 4 is hence formed. Thus, when light is in-coupled via the corner 4, there are four inclined collimating surfaces, each providing collimation parallel and transverse with the planar light emitting surface 3.

FIG. 5 shows a further embodiment of the light guide 1. Generally, the functioning of light guide 1 is the same as previously described. However, the in-coupling corners 4 have a rectangular shape providing better in-coupling efficiency of light into the light guide 1. Thereby also a better overall efficiency can be achieved. More specifically, the rectangular shape can be able to accommodate the complete light emanating surface of an LED (not shown) reducing light leakage between the light guide 1 and the LED.

FIG. 6 shows yet another embodiment of the light guide 1. Generally, the functioning of light guide 1 is the same as previously described. In this embodiment however, the sides 5 are slanting and converge to a single point P-3 forming a pyramidal shaped light guide 1. Thereby each slanting side 5 may reflect more light towards the planar light emitting surface 3 whereby a lower overall brightness of light out-coupled from the light guide 1 may be achieved.

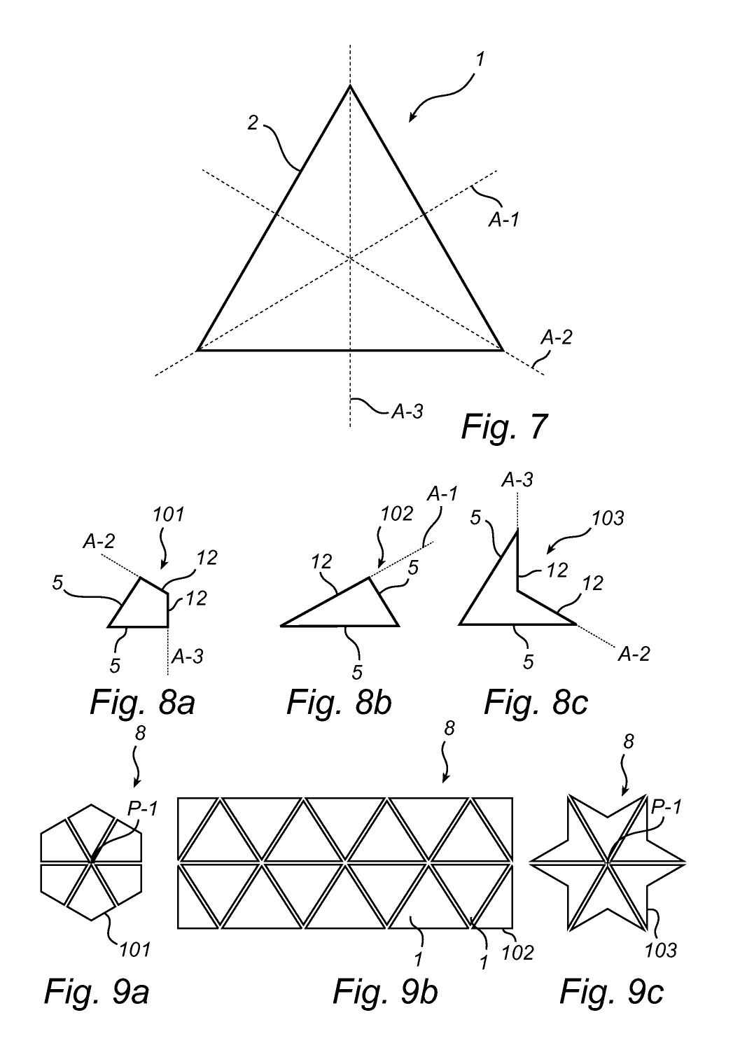

With reference to FIG. 7, a schematic view of an equilateral triangle 2 with each of its symmetry axes A-1, A-2, and A-3 visible is shown.

By the inventors' realization, cutting along anyone of the symmetry axes of the equilateral triangle 2 and mirror coating the side(s) (or alternatively, placing a mirror) along which the cut(s) was/were made thereby forming a reflecting wall 12, light in-coupled at a corner 4 will perceive the formed geometric shape to be an equilateral triangle when traveling therein. Light can be in-coupled at any corner 4 of the new shape for which there is a 60° angle between adjacent slanting sides 5. Alternatively, light can be in-coupled from a corner 4 for which light perceives it to be a 60° angle between a slanting side 5 and its mirror image. This can be possible for instance by cutting along the symmetry axis A-1, forming a corner with a 30° angle between a slanting side 5 and the side 12 along which the cutting was performed. By mirror coating the side 12, light will perceive the lower left corner to have a 60° angle between the horizontal slanting side 5 and its image reflected in the wall 12.

It is to be noted that when cutting along a symmetry axis A-1, A-2 or A-3, the cutting is a normal cut with respect to a plane defined by the planar light emitting surface 3. The remaining sides of the equilateral triangle 2 not subject to cutting are slanting sides 5 for out-coupling of light from the light guide 1. Further, there is an acute angle α (see FIG. 3c) between the slanting side 5 and a plane defined by the planar light emitting surface 3. The acute angle can for instance be between 30° and 65°.

The light guide 1 can be cut along anyone of the symmetry axes A-1, A-2, and A-3. Thereby the light guide 1 forms a geometric shape having at least one side defining a symmetry axis of the equilateral triangle 2. In particular, the light guide 1 can be cut partially along several symmetry axes A-1, A2, and A-3 and thereby forming a more complicated geometric shape.

FIGS. 8a-c shows examples of light guides 1 having been cut along at least one symmetry axis A-1, A-2 and A-3. Light guides 1 shown in FIGS. 8a-c hence all posses the function of the light guide 1 in FIG. 1. In FIG. 8a, cuts have been made along axis A-2 and A-3, resulting in a four-sided polygon shape 101 with two adjacent slanting sides 5, and two reflecting walls 12, each forming a straight angle with respect to one of the slanting sides 5. In FIG. 8b, a cut has been made along axis A-1, resulting in a straight angle triangle shape 102, with two slanted sides 5, and a reflecting wall 12. Light may here be in-coupled in the lower left corner because the image of the adjacent slanting side 5 is reflected in the reflecting wall 12. Light can also be in-coupled at the lower right corner. Finally, in FIG. 8c cuts have been made along axis A-2 and A-3, resulting in an arrow-head shape 103, with two adjacent slanting sides 5, and two reflecting walls 12.

It is possible to combine light guides of different shapes to design a luminaire 8, as indicated by example in FIGS. 9a-c. Some light guides 101, 102, 103 have been cut out from equilateral triangle 2 in FIG. 7 via symmetry axes A-1, A-2, and A-3, while some of the light guides 1 are equilateral triangles.

In FIG. 9a, a hexagonal luminaire 8 is formed using six light guides 101 as shown in FIG. 8a. In FIG. 8b, triangular light guides 1 shown in FIG. 1 have been combined with light guides 102 in FIG. 8b to form a rectangular shaped luminaire 8. In FIG. 9c, a star shaped luminaire 8 is shown, constructed from several light guides 103 shown in FIG. 8c. In-coupling of light may for instance be provided centrally from the point P-1. It is also be possible to in-couple light via any corner of each star shaped light guide 1 as light can be in-coupled in corners where the light perceives a 60° angle between adjacent sides as has been described above.

Applications of the present invention include, but are not limited to, lighting of indoor environments such as office environments, hotels, and shopping centers, as well as outdoor environments comprising lighting systems. More complicated light guides may thereby be replaced by the invention presented herein. Further, luminaries of intriguing shapes and different sizes may be composed by the creative customer.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. The mere fact that certain measures are recited in mutually different dependent claims does not indicate that a combination of these measures cannot be used to advantage. Furthermore, any reference signs in the claims should not be construed as limiting the scope.

1. A light guide having a polygonal shape with a plurality of corners and a plurality of sides, each side connecting two corners, said light guide having a planar light emitting surface, wherein:
at least one of said corners is a light in-coupling corner adapted to allow in-coupling of light into said light guide, wherein
at least one side adjacent to said in-coupling corner is a slanting side forming an acute angle with respect to said light emitting surface, said slanting side being adapted to collimate light in-coupled by said light in-coupling corner and to redirect light towards said planar light emitting surface, and
wherein remaining sides are formed such that light in-coupled in said in-coupling corner is collimated as if said light guide is an equilateral triangle having three slanting sides.

2. The light guide as claimed in claim 1, having three corners and three sides, wherein each side is a slanting side, said light guide having the form of an equilateral triangle.

3. The light guide as claimed in claim 1, wherein all corners are light in-coupling corners.

4. The light guide as claimed in claim 2, wherein said slanting sides converge to a common point thereby forming a three-sided pyramid.

5. The light guide as claimed in claim 1, wherein at least one of said remaining sides is normal to said planar light emitting surface and extends along a line of a symmetry axis of said equilateral triangle.

6. The light guide as claimed in claim 5, wherein said at least one remaining side is a reflecting wall.

7. The light guide as claimed in claim 1, wherein said light in-coupling corner is defined by an in-coupling surface formed between adjacent slanting sides.

8. The light guide as claimed in claim 7, wherein said in-coupling surface is rectangular.

9. The light guide as claimed in claim 7, wherein said light guide has a planar top surface, and wherein said planar top surface and said planar light emitting surface converge towards each other in at least one corner, and intersect said in-coupling surface.

10. A luminaire comprising at least one light guide as claimed in claim 1 and at least one LED located adjacent a light in-coupling corner of at least one light guide, and adapted to in-couple light into said light guide.

11. The luminaire as claimed in claim 10, wherein said at least one LED is located adjacent to in-coupling corners of at least two light guides.
